(19) United States
(12) Patent Application Publication
(10) Pub. No.: US 2024/0083188 A1
(43) Pub. Date: Mar. 14, 2024

(54) DIRECT PRINTING DEVICE WITH UV LIGHTING DEVICE

(71) Applicant: Krones AG, Neutraubling (DE)

(72) Inventor: Andreas MEYER, Nittenau (DE)

(21) Appl. No.: 18/463,223

(22) Filed: Sep. 7, 2023

(30) Foreign Application Priority Data
Sep. 9, 2022 (DE) 10 2022 123 022.8

(51) Int. Cl. B41M 7/00

(52) U.S. Cl. CPC B41M 7/0081

(57) ABSTRACT

A direct printing device for printing on a container comprising: a printing station having one or more print heads for printing on the container with one or more printing inks; a curing station for curing the one or more printing inks having a UV lighting device for curing ink of a direct print on a container using one or more UV LEDs, wherein the UV lighting device may emit UV light at variable wavelengths.

### CROSS REFERENCE TO RELATED APPLICATION

The present application claims priority to German Patent Application No. 102022123022.8 filed on Sep. 9, 2022. The entire contents of the above-listed application are hereby incorporated by reference for all purposes.

### TECHNICAL FIELD

The disclosure relates to a direct printing device for printing a container having a UV light device and to a method for curing one or more printing inks of a direct print on a container.

### BACKGROUND

It is known to directly print containers for products, in particular food, beverages or cosmetics, instead of labeling them. The containers may be of any material, for example, glass, pulp or plastic, or may comprise one or more of the materials. Direct printing devices, which comprise a printing station having one or more print heads, are used for this purpose. After printing on the containers, the printing ink must cure. Curing typically occurs by radiation, in particular UV radiation.

### SUMMARY

As is known, two-dimensional arrays of UV LEDs emitting at a defined wavelength can be used for this purpose. However, such defined wavelength severely limits the choice of substrates and printing materials, since they must all be curable by the defined wavelength. However, there are a variety of different photoinitiators suitable for direct printing of containers, in particular food or beverages, that are curable at different wavelengths. The absorption maximum of each photoinitiator defines the specific wavelength at which it is excited.

The disclosure is now based on the object of providing an improved and, in particular, more flexible direct printing device and a method for curing one or more printing inks of a direct print on a container.

The object is achieved by a direct printing device according to claim 1 and a method for curing one or more printing inks according to claim 12. Further embodiments are set forth in the dependent claims.

The direct printing device comprises a printing station having one or more print heads for printing the container with one or more printing inks. In particular, each print head can be designed to apply a separate printing ink, wherein a primer or a varnish or varnish coating that can be applied by the direct printing method is also considered as printing ink in this connection.

Furthermore, the direct printing device comprises a curing station for curing the one or more printing inks having a UV lighting device. The UV light device comprises one or more UV LEDs for generating the light of the UV light device. The UV light device can emit UV light at variable wavelengths. Thus, it can be particularly suitable for curing inks with different photoinitiators or for use in different curing applications, e.g., pinning or curing.

In particular, the UV light device can be a UV light unit that comprises an array of UV LEDs, in particular a two-dimensional array of UV LEDs. The array can be on a flat or curved section (line) or a flat or curved plane.

Alternatively or additionally, the UV lighting device may be arranged in or comprise a tunnel or circular component, in particular in order to shield the light of the UV LEDs from the environment and, for example, to guide the light on a targeted basis to the containers in the tunnel or in the inner direction or within the circular component.

In particular, a UV light device comprising or configured as a tunnel can comprise one or more UV LEDs arranged laterally on the tunnel wall, in particular on opposite sides of the tunnel wall. In this way, the containers can be irradiated from the side, in particular from both sides, in the tunnel. At the same time, the tunnel can absorb a large part of the UV light so that the risk of exposure to UV light is reduced.

Advantageously, containers may be moved through the tunnel, for example by a transport device, in particular a rotatable transport device such as a turntable, and thus be irradiated with UV light from all sides. The transport device may, but need not be, comprised with the direct printing device.

In a lighting device that comprises multiple UV LEDs, the UV LEDs may be controllable individually, in groups or as one unit.

The illuminating device can comprise one or more first UV LEDs capable of emitting UV light at a first wavelength and one or more second UV LEDs capable of emitting UV light at a second wavelength that is different from the first wavelength. Optionally, one or more further UV LEDs with one or more further wavelengths, in particular different from the previous wavelengths, may also be comprised. The various wavelengths that may be comprised in a light-emitting device comprise, in particular, wavelengths from the UV-A, UV-B, and UV-C ranges. Thus, different steps may be performed with the different wavelengths, e.g., curing of different photoinitiators or pinning and subsequent curing or the like.

The first and/or second and optionally further UV LED(s) may each be designed as individual UV LEDs; in particular, each may be individually controlled and/or individually exchanged. Alternatively or additionally, multiple UV LEDs with the same wavelength may be controlled as a group or all UV LEDs with the same wavelength may be controlled as one unit. Alternatively or additionally, UV LEDs of different wavelengths may be controlled as a group or simultaneously.

The UV LEDs with different wavelengths may be controlled separately. Such a separate controllability of the UV LEDs can make it possible that only UV light of the currently required wavelength(s) is emitted. Thus, the UV lighting device can operate with a high degree of energy efficiency.

With a lighting device, the first UV LEDs, which are capable of emitting UV light at a first wavelength, and second UV LEDs, which are capable of emitting UV light at a first wavelength different from the second wavelength, and optionally further UV LEDs, which are capable of emitting UV light at one or more further wavelengths, the first UV LEDs may be arranged in a first module, the second UV LEDs optionally in a second module and the optionally further UV LEDs in each case optionally in a further module of the specific further wavelength. Each module can comprise one or more connectors by which it can be connected to other parts of the lighting device. Such a modular structure of the lighting device can be advantageous, because it can also enable the modular replacement of damaged modules. The UV LEDs of a module may be switched together or in groups or individually.

The UV light device can comprise one or more tunable UV LEDs. In particular, it may comprise only tunable UV LEDs for generating the UV light, or it may comprise one or more tunable UV LEDs and additionally one or more further UV LEDs, which in particular are capable of emitting UV light at one or more wavelengths that in particular cannot be reached by the tunable UV LED(s).

The one or more tunable UV LEDs may be electronically controllable, for example. For example, depending in particular on the applied power, they may emit UV light at two or more wavelengths that are more than 5 nm, in particular more than 10 nm, for example more than 15 nm apart.

With a UV light device with more than one tunable UV LED, the tunable UV LEDs may be controllable individually or together or in groups.

The UV light device can be controllable to emit light at different wavelengths simultaneously. Thus, with multiple UV LEDs, each emitting light of one wavelength, multiple UV LEDs with different wavelengths may emit UV light simultaneously. In the case of tunable UV LEDs, these can in particular be controlled independently of one another, so that different tunable UV LEDs emit UV light of different wavelengths simultaneously.

The UV lighting device may alternatively or additionally be controllable to emit UV light at different wavelengths in succession. In particular, UV LEDs with different wavelengths, each emitting light of one wavelength, may thus be controllable separately from one another, so that they emit UV light in succession and/or tunable UV LEDs can be controlled, so that they emit UV light at different wavelengths in succession.

The power of the UV lighting device can be controllable. In particular, individual UV LEDs or groups of UV LEDs and/or modules of UV LEDs can be switched on and off, so that its desired output, optionally at a desired wavelength, can be generated. Alternatively or additionally, the power can be controlled for individual UV LEDs, groups of UV LEDs and/or modules of UV LEDs; in particular, it can be adjusted between a minimum and a maximum value. This allows the desired light output to be adjusted to the containers in such a manner that the necessary curing is achieved while minimizing the energy required for this purpose.

Optionally, the powers of the UV light device can be adjustable at a first wavelength and at a second wavelength different from the first wavelength, in particular independently of one another. This can make it possible to regulate the curing of individual colors, in particular when using inks with different photoinitiators. Optionally, the power or powers at one or more further wavelengths can be adjustable independently of the preceding powers at other wavelengths.

In particular, the curing station can comprise one or more sensors for checking the cured printing. In particular, this one or more sensors can comprise one or more optical sensors, in particular in one or more cameras. In the case of a sensor comprised in a camera, an optical image of the printed image can be recorded in particular. Alternatively or additionally, one or more sensors can be designed as sensors for measuring the scratch resistance of the printed image, for example by measuring a hardness of the printed image. Alternatively or additionally, the scratch resistance of the printed image may be determined using a sensor, in particular an optical sensor, e.g., in a camera, for example by scratching on the printed image and then measuring, in particular optically, whether a visible scratch can be seen on the printed image, thus checking the cured print.

In particular, the one or more sensors can capture the print image of the cured print; optionally, the captured print image can then be analyzed, e.g., for image sharpness, color depth, and the like.

The curing station can further comprise a controller that is designed to analyze the cured print using the one or more sensors to check the cured print and based on the analysis, adjust one or more parameters of the UV light device, such as the power(s) at one or more wavelengths. For example, the analysis can comprise an analysis of a captured print image for image sharpness, color depth and/or the like. Thus, the print, in particular the printed image, can be optimized by setting optimal curing parameters, e.g., the power of the wavelength during pinning and/or the power of the wavelength during final curing and/or the power at the wavelength for a particular photoinitiator.

In particular, the power can be adjusted for a specific part or region of the UV light device, for example of less than 50%, for example less than 25%, in particular less than 10% of the UV LEDs comprised by the UV light device and/or an area of less than 50%, for example less than 25%, in particular less than 10% of the area of the UV light device. In this manner, problem regions of the print image in particular can be corrected on a targeted basis.

For example, the controller can comprise a control loop or artificial intelligence that continuously analyzes the cured print and, based on the analysis, readjusts one or more parameters of the UV illuminator. Thus, for example, automated output control can take place, and in particular full automation can be made possible.

The device can further comprise sensors, in particular in the curing station, which can detect the intensity and/or the light spectrum and/or the wavelengths of the currently switched-on UV LEDs. In addition, the device can comprise sensors that measure environmental parameters such as temperature, air pressure, and/or humidity, which may have an effect on ink curing. One, more or all of such values can also be taken into account by the controller, in particular when readjusting one or more parameters of the UV lamp device.

The disclosure further comprises a method for curing one or more inks of a direct print on a container using a light emitting device for curing ink of a direct print on a container using one or more UV LEDs, wherein the UV light emitting device emits UV light at multiple wavelengths when curing the one or more inks. In particular, the method can be carried out in a direct printing device described above. It can further use a UV light device as described above, which can emit UV light at variable wavelengths.

Furthermore, the method can comprise one or more of the steps described above as being performable by the device in relation to the UV lighting device, in particular control steps of the UV LEDs in the lighting device as described above as being controllable and control steps of the lighting device, along with steps performed by and/or described in relation to the controller, in particular the steps of readjusting the parameters of the UV lighting device, for example based on an analysis of the printing.

With the method (and also in the device described above), two or more printing inks with two or more different photoinitiators can be used in particular. Thereby, a first and a second (and optionally one or more further) photoinitiators can be activated, in particular, by two (optionally three or more) wavelengths, wherein the absorption maxima of the photoinitiators can differ by at least 5 nm, for example by at least 10 nm, in particular by 30 nm to 50 nm. In particular, natural tailing can be taken into account so that the absorption spectrum of one photoinitiator does not fall too much into the absorption spectrum of the second photoinitiator. This allows the different photoinitiators to be cured by different wavelengths, for example, using a device described above. In particular, when using photoinitiators that absorb at only one specific wavelength, the wavelengths for activating two (or more) photoinitiators are different enough, i.e., in particular, for example, more than 2 nm, e.g., more than 10 nm, in particular, more than 15 nm apart, an ink with a first photoinitiator can be cured, while another ink (in particular, another ink already applied) with a photoinitiator is not cured by the UV radiation. Thus, in particular, selective curing of different printing inks and/or readjustment of the parameters of the UV light device can be carried out on a targeted basis for one printing ink or one photoinitiator in each case.

For example, UV LEDs emitting in a wavelength range from 100 nm to 400 nm can be used in the device and in the method.

Typical area powers of UV LED emitters when used in direct printing methods may range from 0.1 W/cm² to 30 W/cm². Typical area powers of a UV light device, as may be used in a previously described device and method, may range from 0.1 W/cm² to 6 W/cm².

### BRIEF DESCRIPTION OF THE FIGURES

Other aspects of the disclosure are described in the following figures, which are not to scale. In the figures:

FIGS. 1A and 1B show exemplary UV light devices with UV LEDs of first and second wavelength,

FIG. 2 shows a direct printing device having a UV lighting device with a tunnel,

FIG. 3 shows a direct printing device having a UV lighting device with a circular component,

FIG. 4 shows a direct printing device having a UV lighting device with a circular component.

### DETAILED DESCRIPTION

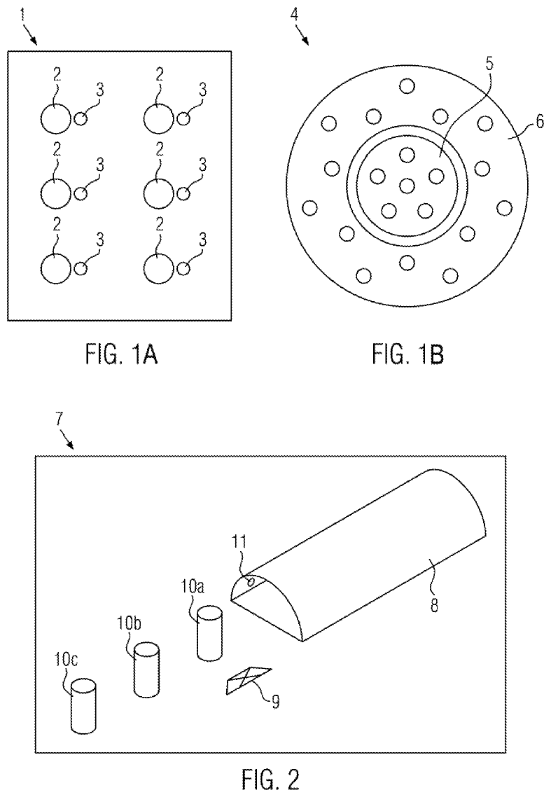

FIG. 1A shows an exemplary UV light device 1. As an example, the UV light device shown comprises 12 UV LEDs, of which six UV LEDs emit 2 UV light of a first wavelength and six UV LEDs emit 3 UV light of a second wavelength. For better visibility, the UV LEDs, which emit light of different wavelengths, are drawn here in different sizes. However, this does not have to be the case.

In the example shown, two UV LEDs of different wavelengths are arranged side by side, and such pairs of UV LEDs are arranged in a regular two-dimensional grid. In other embodiments, such juxtaposed UV LED pairs may also be arranged in an irregular one-dimensional or two-dimensional grid.

In other examples (not shown here), such a UV light device can also comprise more or less than 12 UV LEDs and/or the number of first and second wavelength UV LEDs can be unequal. Furthermore, additional UV LEDs, e.g., with a third or even further wavelengths may be comprised (not shown).

The exemplary UV LEDs 2, 3 are mounted in a two-dimensional array. In the example shown, these are arranged on a flat surface. In other examples, the UV LEDs may also be arranged on curved two-dimensional surfaces, or on a straight line or curved one-dimensional line.

FIG. 1B shows another exemplary UV light device 4, in which UV LEDs of a first wavelength are arranged in a first module 5 and UV LEDs of a second wavelength are arranged in a second module 6. The array of the individual UV LEDs in the modules is only exemplary; they can also be arranged differently. In the example shown, module 5 is surrounded by module 6. In other embodiments, the modules may have a different shape and/or may be arranged side by side. In addition, further modules with UV LEDs of first, second or a third and/or further wavelengths may optionally be comprised (not shown).

FIG. 2 shows an exemplary direct printing device 7 in which the UV light device comprises a tunnel 8; in particular, it is designed as a tunnel 8. In this example, the tunnel 8 is arranged along a straight line. In other examples, a tunnel may also be arranged along a curved path (not shown).

The one or more UV LEDs may be arranged internally on the wall of the tunnel, particularly on a side wall of the tunnel. For example, multiple UV LEDs may be arranged on opposite walls of the tunnel 8, so that they can irradiate containers in the tunnel with UV light from two sides. The UV LEDs may be arranged along the direction of passage through the tunnel on the inner wall. This may be particularly advantageous if the containers are transported rotatably in the tunnel because this allows irradiation of the direct print from all sides.

In the example shown, exemplary containers 10a, 10b, 10c are conveyed in the direction of the tunnel 8. In front of the tunnel 8, the container 10a is printed at the position of the print head 9 by the print head 9 and then moved, e.g., on a transport means such as a turntable, through the tunnel 8 of the UV light device. Optionally, more than one print head 9 may be provided at the beginning of the tunnel, and optionally the additional print head(s) may print the same or a different color on the container than a first print head 9 at the beginning of the tunnel.

As shown, the one or more UV LEDs 11 of the illuminating device may be arranged in the tunnel 8 (for example, only one UV LED 11 is visible at the beginning of the tunnel in this example). At the same time, a large part of the UV light can be prevented from escaping through the tunnel wall, so that the UV light does not endanger people.

In a direct printing device, more than one such tunnel with one or more print heads may also be comprised at the beginning of the tunnel (not shown).

The UV LEDs may be or comprise tunable UV LEDs. Alternatively, UV LEDs of at least two different wavelengths can be arranged in the tunnel, which can optionally be switched separately, in particular independently of one another.

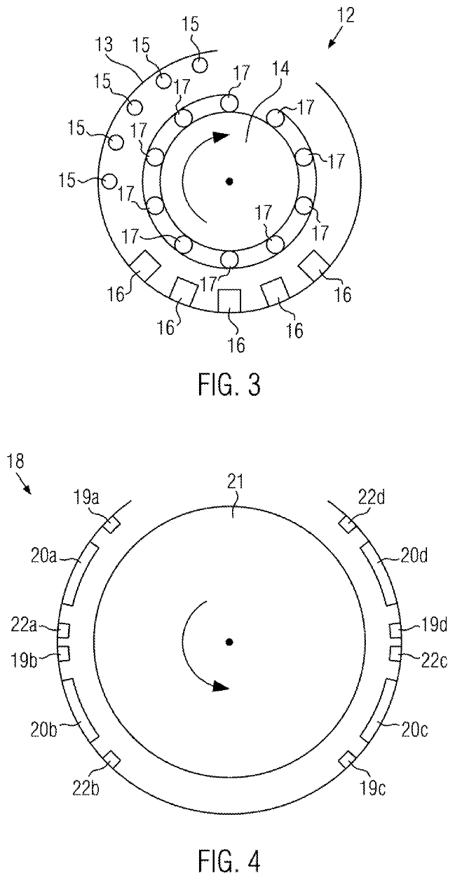

FIG. 3 shows a direct printing device 12, in which the UV lighting device 13 is designed as part of a circular component. In particular, the circular component may follow the shape of a transport carousel 14 or similar container conveyor. In the example shown, UV LEDs 15 are optionally fastened to the circular component so that they shine in the direction of the centers of the circular component and the circular component is closed to the extent that light from the UV LEDs 15 is shielded from the circular component and does not end up outside the circular component. In particular, this can reduce the likelihood of UV light falling on an operator and endangering them.

In the example shown, the direct printing device 12 is designed to have multiple print heads 16 arranged along a portion of the circular blank. The containers 17 may be moved past the print heads 16 on a conveyor, which is designed here as an exemplary conveyor carousel 14, and printed in the process. The conveyor may, but need not be, comprised in the direct printing device. For example, the containers may be rotated on the conveyor, for example on turntables, so that they can be printed from all sides. Subsequently, the printed containers may be irradiated with UV light by the UV lighting device of the circular component 13, so that the printing ink cures. Optionally, UV LEDs may be irradiated with multiple wavelengths simultaneously or with only one wavelength at a time.

For example, the device may be controlled to print one specific color per print head. For example, the device may be controllable, in particular controlled, such that a container is printed by a print head; and subsequently the applied ink is cured in the UV light device, in particular with the wavelength suitable for the ink printed by the print head. For this purpose, the UV light device may be controlled to emit UV light of the corresponding wavelength, in particular only UV light of the corresponding wavelength. Subsequently, such steps can be repeated with a next print head, e.g., in a next pass around the conveyor. Such steps of printing and curing the respective ink, optionally with control of the UV illuminator that it irradiates the container with the appropriate wavelength for the respective print head, can be repeated for each ink to be applied.

In other examples, the container may first be printed with multiple inks and then the inks may be cured by the light-emitting device, in particular with one or more wavelengths suitable for curing the inks.

Optionally, a sensor for checking the cured printed can be arranged (in the direction of travel of the container) downstream of the UV light device (not shown). Using the sensor, a controller can analyze the cured print and, based on the analysis, readjust one or more parameters of the UV light device. Optionally, the print can be analyzed by color. In particular, if different photoinitiators are used for different colors, the printed image can then be improved by adjusting the power of the UV light device, in particular the power at the wavelength required for the particular photoinitiator of the analyzed color.

FIG. 4 shows another direct printing device 18, which comprises multiple print heads 19a, b, c, d and multiple illuminators 20a, 20b, 20c, 20d. The light-emitting devices 20a, 20b, 20c, 20d are each arranged (in the direction of travel of the container) behind the print heads 19a, 19b, 19c, 19d. Optionally, more than one print head may be comprised in front of each illuminator 20a, 20b, 20c, 20d (not shown). Alternatively or additionally, the direct printing device may comprise more or less than 4 light emitting devices, and for each of the light emitting devices, one or more print heads (not shown).

In particular, one, more or all of the illuminating devices 20a, 20b, 20c, 20d may thereby emit UV light at variable wavelengths. Such an arrangement of the printing device allows the inks to be applied in succession and hardened with a wavelength suitable for the applied ink before the next ink is applied. In particular, the specified device also allows different printing materials to be used in different printing operations without having to use different illuminating devices.

With the arrangement shown, a conveyor drawn on the exemplary conveyor carousel 21 can be transported in such a manner that it is printed at each print head with an ink which is then cured by the following light devices, in particular with the wavelength suitable for the ink. By curing the respective color before applying the next color, the print image can be improved. The conveyor may, but need not be, comprised in the direct printing device.

Optionally, a sensor 22a, 22b, 22c, 22d can be arranged (in the direction of travel of the container) between the illuminating device and the subsequent next printing device for checking the cured print; thus, for each printing ink individually, the cured print can be analyzed and, based on the analysis, one or more parameters of the preceding UV illuminating device can be readjusted. In other examples (not shown here), instead of the four sensors shown as examples for checking the cured print, only one or more, but not all, of the sensors shown may be comprised; in particular, only the sensor 22d may be comprised. If a separate sensor is not comprised for each ink applied, the analysis of the print can comprise, in particular, analyzing the print image separately by ink and also analyzing which of the UV illuminators needs to be readjusted and then readjusting it.

1. A direct printing device for printing on a container, comprising
a printing station having one or more print heads for printing
a curing station for curing the one or more printing inks having a UV lighting device for curing printing ink of a direct print on a container using one or more UV LEDs,
wherein
the UV lighting device may emit UV light at variable wavelengths.

2. The direct printing device according to claim 1, wherein the lighting device comprises one or more first UV LEDs capable of emitting UV light at a first wavelength and one or more second UV LEDs capable of emitting UV light at a second wavelength different from the first wavelength.

3. The direct printing device according to claim 2, wherein the first UV LEDs and/or the second UV LEDs are arranged as single UV LEDs in the lighting device.

4. The direct printing device according to claim 2, wherein the first UV LEDs are incorporated in a first module, and the second UV LEDs are optionally incorporated in a second module.

5. The direct printing device according to claim 1, wherein the UV lighting device comprises at least one tunable UV LED.

6. The direct printing device according to claim 1, wherein the UV lighting device is controllable so that it emits UV light at different wavelengths simultaneously.

7. The direct printing device according to claim 1, wherein the UV lighting device is controllable so that it emits UV light at different wavelengths in succession.

8. The direct printing device according to claim 1, wherein the power of the UV lighting device is controllable.

9. The direct printing device according to claim 8, wherein the power of the UV lighting device may be adjusted at a first wavelength and at a second wavelength different from the first wavelength, in particular independently of one another.

10. The direct printing device according to claim 1, wherein the curing station comprises one or more sensors for checking the cured print.

11. The direct printing device according to claim 10, wherein the curing station comprises a controller, which is designed to analyze the cured print using the one or more sensors for checking the cured print and, based on the analysis, to adjust one or more parameters of the UV lighting device.

12. A method for curing one or more printing inks of a direct printing on a container, wherein the one or more printing inks are cured using a UV lighting device for curing printing ink of a direct printing on a container using one or more UV LEDs, wherein the UV lighting device emits UV light at multiple wavelengths when curing the one or more printing inks.
